(19) United States
(12) Patent Application Publication
(10) Pub. No.: US 2026/0341078 A1
(43) Pub. Date: Oct. 29, 2026

(54) FACIAL RECOGNITION METHOD AND APPARATUS

(71) Applicant: BEIJING LONGZHI DIGITAL TECHNOLOGY CO., LTD., Beijing (CN)

(72) Inventor: Xiahong WANG, Beijing (CN)

(73) Assignee: BEIJING LONGZHI DIGITAL TECHNOLOGY CO., LTD., Beijing (CN)

(21) Appl. No.: 19/107,037

(22) PCT Filed: Nov. 2, 2022
(86) PCT No.: PCT/CN2022/129343

§ 371 Date: Feb. 27, 2025

(30) Foreign Application Priority Data
Aug. 31, 2022 (CN) 202211055844.7

(51) Int. Cl. G06V 40/16; G06V 10/77; G06V 10/82

(52) U.S. Cl. CPC G06V 40/171; G06V 10/7715; G06V 10/82; G06V 40/172

(57) ABSTRACT

A facial recognition method and an apparatus are provided. The method includes: acquiring a first feature map of a facial image to be recognized; performing depthwise convolution processing on the first feature map, so as to obtain a second feature map; performing attention circulation processing on the second feature map, so as to obtain a third feature map; and sequentially performing, on the third feature map, channel increasing convolution processing, attention circulation processing, channel reducing convolution processing, and attention circulation processing, so as to obtain a target feature map corresponding to the first feature map.

### CROSS REFERENCE TO THE RELATED APPLICATIONS

This application is the national phase entry of International Application No. PCT/CN2022/129343, filed on Nov. 2, 2022, which is based upon and claims priority to Chinese Patent Application No. 202211055844.7, filed on Aug. 31, 2022, the entire contents of which are incorporated herein by reference.

### TECHNICAL FIELD

The present disclosure relates to the field of computer technologies, and in particular, to a facial recognition method and apparatus.

### BACKGROUND

In a practical application process, a facial technology is often required to be deployed to a cloud and an edge, and due to limitations of computing power and storage resources of the edge, such as an embedded terminal, or the like, an edge facial recognition model is required to meet the requirements of a small model size, low computing complexity, a high reasoning speed, or the like, while meeting a high-precision requirement.

In the related art, common lightweight networks capable of realizing facial recognition tasks include SqueezeNet, MobileNet, ShuffleNet, or the like, and due to particularity of facial structures, the models are poor in precision for the facial recognition tasks. A mobile terminal lightweight network MobileFaceNet specially designed for the facial recognition task adopts a smaller expansion rate based on MobileNet, and a global average pooling layer is replaced with a global depthwise convolution layer. However, a main building module of MobileFaceNet still is a common residual bottleneck module, and calculations of the modules are also the same, such that the problem of poor precision also exists.

### SUMMARY

In view of this, embodiments of the present disclosure provide a facial recognition method and apparatus, an electronic device, and a computer-readable storage medium, so as to solve the problem in the prior art that precision of a facial recognition model is poor.

In a first aspect of the embodiments of the present disclosure, there is provided a facial recognition method, including: acquiring a first feature map of a facial image to be recognized; performing depthwise convolution processing on the first feature map, so as to obtain a second feature map; performing attention circulation processing on the second feature map, so as to obtain a third feature map; and sequentially performing, on the third feature map, channel increasing convolution processing, attention circulation processing, channel reducing convolution processing, and attention circulation processing, so as to obtain a target feature map corresponding to the first feature map.

In a second aspect of the embodiments of the present disclosure, there is provided a facial recognition apparatus, including: an acquiring module configured to acquire a first feature map of a facial image to be recognized; a convolution module configured to perform depthwise convolution processing on the first feature map, so as to obtain a second feature map; an attention circulation module configured to perform attention circulation processing on the second feature map, so as to obtain a third feature map; and a hybrid processing module configured to sequentially perform, on the third feature map, channel increasing convolution processing, attention circulation processing, channel reducing convolution processing, and attention circulation processing, so as to obtain a target feature map corresponding to the first feature map.

In a third aspect of the embodiments of the present disclosure, there is provided an electronic device, including a memory, a processor and a computer program stored in the memory and runnable on the processor, wherein the processor, when executing the computer program, implements the steps of the above method.

In a fourth aspect of the embodiments of the present disclosure, there is provided a computer-readable storage medium storing a computer program, wherein the computer program, when executed by a processor, implements the steps of the above method.

Compared with the prior art, the embodiments of the present disclosure have the following beneficial effects: feature map processing of facial recognition is carried out through a combination of the convolution processing and the attention circulation processing, and circulation of attention in multiple directional dimensions is promoted, such that the finally obtained feature map has high discrimination on all the directional dimensions, thereby improving recognition precision of a facial recognition model.

Specifically, the embodiment of the present disclosure provides the lightweight attention circulation module, a tensor of the attention circulation module has a quite low dimension, and a convolution calculation quantity of the low-dimension tensor is quite small, thus realizing a relatively high overall operation speed. If the whole network carries out feature extraction in a low-dimensional space, incompleteness of information and unrobustness of features are likely to be caused, and in the embodiment of the present disclosure, channel number expansion with a set expansion coefficient is carried out in the middle convolution processing process, such that a feature extraction capability of the whole module can be improved to realize delicate balance between the calculation quantity and a feature expression capability.

In the embodiment of the present disclosure, the whole attention circulation module enables an attention flow concerned by a facial recognition task to be circulated and transformed between spaces and channels through a combination of operations, such as convolutions, expansion and compression of channel numbers, attention circulation technologies, or the like, of different types, feature fusion is more efficient, the feature map is finally and effectively focused on an interested region of facial recognition, and furthermore, the attention circulation module also has the advantages of a small parameter number, a small calculation quantity and a high speed.

### BRIEF DESCRIPTION OF THE DRAWINGS

In order to more clearly illustrate the technical solutions in the embodiments of the present disclosure, the accompanying drawings used in the description of the embodiments or the prior art will be briefly introduced below. It is apparent that, the accompanying drawings in the following description are only some embodiments of the present disclosure, and other drawings can be obtained by those of ordinary skill in the art from the provided drawings without creative efforts.

FIG. 1 is a schematic diagram of an application scenario of an embodiment of the present disclosure;

FIG. 2 is a schematic flowchart of a facial recognition method according to an embodiment of the present disclosure;

FIG. 3 is a schematic flowchart of attention circulation processing in an embodiment of the present disclosure;

FIG. 4 is a schematic flowchart of another facial recognition method according to an embodiment of the present disclosure;

FIG. 5 is a schematic structural diagram of a facial recognition apparatus according to an embodiment of the present disclosure; and

FIG. 6 is a schematic structural diagram of an electronic device according to an embodiment of the present disclosure.

### DETAILED DESCRIPTION OF THE EMBODIMENTS

In the following description, for the purpose of illustration instead of limitation, specific details such as a particular system structure and a technology are provided to make the embodiments of the present disclosure understood thoroughly. However, it should be understood by those skilled in the art that the present disclosure can also be implemented in other embodiments without the specific details. In other cases, detailed description of well-known systems, apparatuses, circuits and methods is omitted, so that the present disclosure is described without being impeded by unnecessary details.

A facial recognition method and apparatus according to embodiments of the present disclosure will be described in detail below with reference to the accompanying drawings.

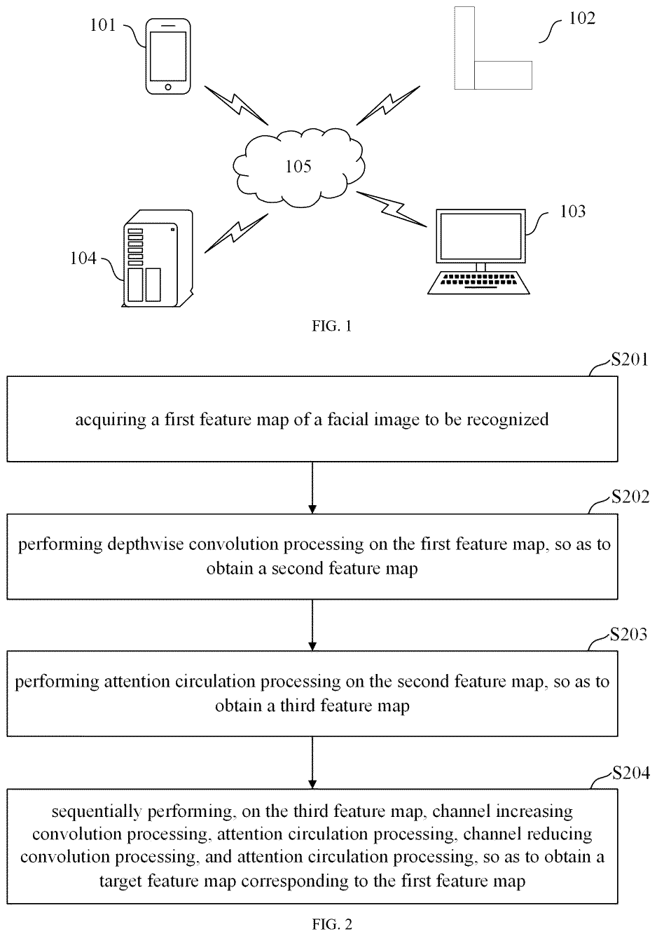

FIG. 1 is a schematic diagram of an application scenario of an embodiment of the present disclosure. The application scenario may include terminal devices 101, 102 and 103, a server 104 and a network 105.

The terminal devices 101, 102 and 103 may be hardware or software. When the terminal devices 101, 102 and 103 are hardware, the terminal devices may be various electronic devices having display screens and supporting communication with the server 104, including but not limited to smart phones, robots, laptop portable computers, desktop computers, or the like (for example, 102 may be robots); when the terminal devices 101, 102 and 103 are software, the terminal devices may be installed in the above electronic device. The terminal devices 101, 102 and 103 may be implemented as a plurality of pieces of software or software modules, or may be implemented as a single piece of software or software module, which is not limited in the embodiment of the present disclosure. Further, various applications, such as a data processing application, an instant messaging tool, social platform software, a search type application and a shopping type application, may be installed on the terminal devices 101, 102 and 103.

The server 104 may be a server providing various services, for example, a background server receiving a request sent by a terminal device establishing communication connection with the server, and the background server may receive and analyze the request sent by the terminal device, and generate a processing result. The server 104 may be a server, or a server cluster composed of a plurality of servers, or a cloud computing service center, which is not limited in the embodiment of the present disclosure.

It should be noted that the server 104 may be hardware or software. When the server 104 is hardware, the server may be various electronic devices providing various services for the terminal devices 101, 102 and 103. When the server 104 is software, the server may be plural pieces of software or software modules providing various services for the terminal devices 101, 102 and 103, or may be a single piece of software or software module providing various services for the terminal devices 101, 102 and 103, which is not limited in the embodiment of the present disclosure.

The network 105 may be a wired network formed by connection using a coaxial cable, a twisted pair cable, and an optical fiber, or may be a wireless network which can interconnect various communication devices without wiring, for example, Bluetooth, Near Field Communication (NFC), Infrared, or the like, which is not limited in the embodiment of the present disclosure.

A target user can establish communication connection with the server 104 through the network 105 by the terminal devices 101, 102 and 103 to receive or transmit information, or the like. It should be noted that specific types, numbers, and combinations of the terminal devices 101, 102 and 103, the server 104 and the network 105 may be adjusted according to actual needs of the application scenario, which is not limited in the embodiment of the present disclosure.

In the related art, computing power and storage resources of an edge, such as an embedded terminal, or the like, are limited, and can only support a small model size, and facial recognition precision of a general lightweight facial large model is not high.

In order to solve the technical problem, the embodiment of the present disclosure provides a facial recognition solution, in which a concise and effective lightweight general model for extracting face features is designed, and a facial recognition model with a real-time response is specially designed for the edge end and an embedded device, so as to improve the facial recognition precision.

Specifically, the technical solution of the embodiment of the present disclosure provides a universal attention circulation technology, which can effectively capture attention on a space and a channel, and improve feature discrimination in a channel-wise learnable nonlinear mapping mode, and the whole technology can extract an effective feature combination mode, thereby promoting circulation of the attention in multiple directional dimensions.

FIG. 2 is a schematic flowchart of a facial recognition method according to an embodiment of the present disclosure. The method according to the embodiment of the present disclosure can be executed by any electronic device with a computer processing capability, such as a terminal or a server. As shown in FIG. 2, the facial recognition method includes:
step S201: acquiring a first feature map of a facial image to be recognized.

Specifically, the first feature map is a 4-dimensional tensor having dimensions (N, C, H, W), N representing a number of batch-processed images, C representing a number of channels, H representing a height, and W representing a width. The first feature map is obtained by extracting features of the facial image to be recognized.
Step S202: performing depthwise convolution processing on the first feature map, so as to obtain a second feature map.

Specifically, for a depthwise convolution (DWConv), a convolution operation is performed in each independent channel, each convolution kernel performs one calculation on each channel in a conventional convolution, and each convolution kernel performs calculations on only one channel in the depthwise convolution.
Step S203: performing attention circulation processing on the second feature map, so as to obtain a third feature map.

Specifically, the attention circulation processing may cause the attention to be circulated between the spaces and the channels to perform more effective feature fusion.
Step S204: sequentially performing, on the third feature map, channel increasing convolution processing, attention circulation processing, channel reducing convolution processing, and attention circulation processing, so as to obtain a target feature map corresponding to the first feature map.

Specifically, the channel increasing convolution processing and the channel reducing convolution processing are two corresponding conventional convolution calculation processes, the channel increasing convolution processing is performed first to increase the number of the channels, and then, the channel reducing convolution processing is performed to restore the number of the channels to the previous number.

According to the technical solution of the embodiment of the present disclosure, through the attention circulation processing, the effective feature combination mode can be extracted to promote the circulation of the attention in multiple directional dimensions. Through the design and combination of the attention circulation processing technology and different types of convolutions, requirements of the facial recognition task and lightweight requirements of the embedded device can be met simultaneously, and compared with the prior art, higher recognition precision can be realized by using a smaller number of parameters.

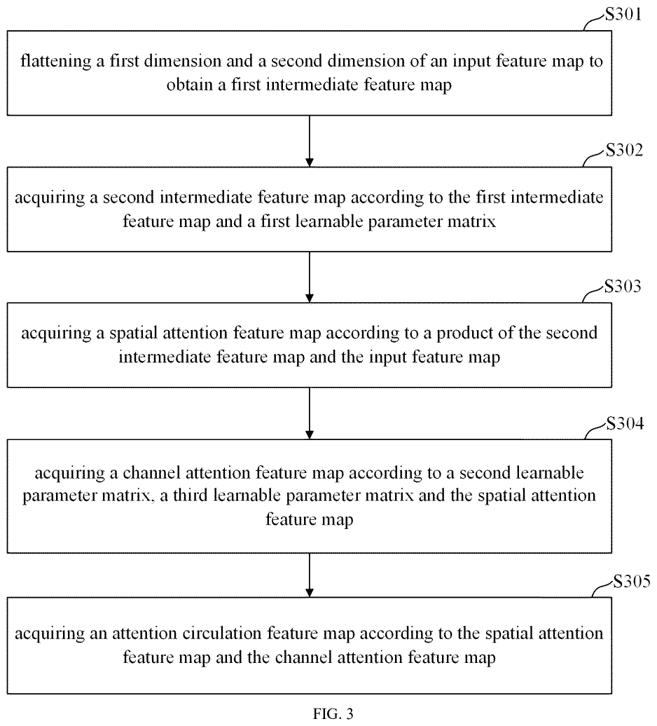

As shown in FIG. 3, the attention circulation processing in the step S203 and the step S204 includes the following steps:
step S301: flattening a first dimension and a second dimension of an input feature map to obtain a first intermediate feature map.

Specifically, the first dimension may be the height and the second dimension may be the width. Assuming that the input feature map is f₁, by flattening the two dimensions of height and width of f₁, the dimensions (N, C, H, W) can be transformed into (N, C, R), wherein R=H*W.
Step S302: acquiring a second intermediate feature map according to the first intermediate feature map and a first learnable parameter matrix.

In the technical solution of the embodiment of the present disclosure, a first product of the first intermediate feature map and a function value of a logistic regression function softmax thereof may be obtained, and then, the second intermediate feature map may be obtained according to a mean value of the first product. Specifically, the first intermediate feature map may be right multiplied by the first learnable parameter matrix to obtain a tensor, a Hadamard product of the softmax function value of the tensor and the tensor is further calculated to obtain a matrix, and the matrix is averaged in a certain dimension to obtain the second intermediate feature map. The first learnable parameter matrix may learn attention circulation information in a spatial dimension.
Step S303: acquiring a spatial attention feature map according to a product of the second intermediate feature map and the input feature map.

Specifically, the spatial attention feature map is a spatial attention-fused feature map.
Step S304: acquiring a channel attention feature map according to a second learnable parameter matrix, a third learnable parameter matrix and the spatial attention feature map, a first dimension of the second learnable parameter matrix being equal to a second dimension of the third learnable parameter matrix, and a first dimension of the third learnable parameter matrix being equal to a second dimension of the second learnable parameter matrix.

Specifically, the spatial attention feature map may be right multiplied by the second learnable parameter matrix to obtain a second product; the second product is subjected to sparsification and right multiplied by the third learnable parameter matrix to obtain the channel attention feature map. The second learnable parameter matrix and the third learnable parameter matrix can learn attention circulation information in a channel dimension, and weights of the channels are learned by capturing feature relationships between different channels, such that features are more discriminative for information of the channels.
Step S305: acquiring an attention circulation feature map according to the spatial attention feature map and the channel attention feature map.

Specifically, when the attention circulation feature map is obtained according to the spatial attention feature map and the channel attention feature map, the spatial attention feature map may be subjected to nonlinear mapping processing to obtain a third intermediate feature map; a fourth intermediate feature map is obtained according to a product of the third intermediate feature map and the channel attention feature map; and nonlinear mapping processing is performed on the fourth intermediate feature map to obtain the attention circulation feature map. The attention circulation feature map obtained according to the spatial attention feature map and the channel attention feature map can learn the attention circulation information in the spatial dimension and the channel dimension, thereby improving accuracy of attention circulation in the spatial dimension and the channel dimension.

The following describes the step S301 to the step S305 in detail.

In the step S301, assuming that the input feature map is f₁ having the dimensions (N, C, H, W), the two dimensions H and W of f₁ are flattened, and the dimensions are transformed into (N, C, R), so as to obtain the second intermediate feature map, wherein R=H*W.

In order to learn the attention in the dimension of the feature H*W to cause the attention to be circulated in the spatial dimension, in the embodiment of the present disclosure, the first learnable parameter matrix Q₁ is introduced and has dimensions (R, r) (r<R).

In the step S302, the first intermediate feature map obtained after dimension transformation is right multiplied by Q₁ to obtain the tensor f′₁ with dimensions (N, C, r), a softmax operation is performed in the dimension r of f′₁ to obtain a tensor Aₛ with dimensions (N, C, r), and corresponding elements of f′₁ and Aₛ in the dimension r are multiplied, that is, the Hadamard product of f′₁ and Aₛ is obtained, so as to obtain the matrix M₁ with a size (N, C, r); M₁ represents fusion of a plurality of feature combinations, and the larger the r is, the higher the complexity is. M₁ is averaged according to the dimension r, the dimension is compressed to 1 to obtain the second intermediate feature map

$${f}_{1}^{s}$$

having dimensions (N, C), and a specific calculation process is shown in the following formula (1):

$${f}_{1}^{s} = avg ( ( flatten ( {f}_{1} ) * {Q}_{1} ) \cdot softmax ( flatten ( {f}_{1} ) * {Q}_{1} ) ) \qquad ( 1 )$$

In the embodiment of the present disclosure, the first learnable parameter matrix Q₁ is introduced to calculate and obtain r kinds of spatial linear transformation results, and all representative feature combination modes in the space can be extracted. In the extracted face feature map, although spatial pixels have the same receptive field, the receptive fields are mapped to different regions of the original image and have different contributions to the final recognition task, and therefore, different weights should be given to different pixels. The attention in the dimension H*W of the features can be learned by using the first learnable parameter matrix Q₁, such that the attention is circulated in the spatial dimension to obtain a fusion result of the plurality of feature combinations.

In the step S303, the second intermediate feature map

$${f}_{1}^{s}$$

output in the step S301 is multiplied by f₁ to obtain the spatial attention feature map

$${f}_{1}^{{s}^{′}}$$

having the dimensions (N, C, H, W), and a specific calculation process is shown in the following formula (2):

$${f}_{1}^{{s}^{′}} = {f}_{1} {f}_{1}^{s} \qquad ( 2 )$$

wherein

$${f}_{1}^{{s}^{′}}$$

is the feature map with the spatial attention fused.

In the step S304, the spatial attention feature map with the dimensions (N, C, H, W) is introduced into the second learnable parameter matrix Q₂ and the third learnable parameter matrix Q₃ for processing, so as to obtain the channel attention feature map

$${f}_{1}^{c} .$$

Specifically, the second learnable parameter matrix Q₂ has dimensions (C, C//p), and the third learnable parameter matrix Q₃ has dimensions (C//p, C), C being a natural number. It can be seen that the first dimension of the second learnable parameter matrix is equal to the second dimension of the third learnable parameter matrix, and the first dimension of the third learnable parameter matrix is equal to the second dimension of the second learnable parameter matrix.

$${f}_{1}^{s}$$

is right multiplied by Q₂ to obtain dimensions (N, C//p), sparsification is performed by relu, and a result is right multiplied by Q₃ to obtain the channel attention feature map

$${f}_{1}^{c}$$

with dimensions (N, C).

A specific calculation process is shown in the following formula 3

$${f}_{1}^{c} = relu ( {f}_{1}^{{s}^{′}} * {Q}_{2} ) * {Q}_{3} \qquad ( 3 )$$

In the step S305, the attention circulation information in the channel dimension can be learned by the second learnable parameter matrix Q₂ and the third learnable parameter matrix Q₃ introduced in the step S304, a feature relationship between the channels is more concerned in the design of this part, and a weight of each channel is learned by capturing the feature relationship between different channels, such that the features are more discriminative for each piece of channel information. P represents a scaling coefficient, and the parameter p can be designed to reduce a calculation quantity and control the size of the model.

The channel attention feature map

$${f}_{1}^{{s}^{′}}$$

is subjected to nonlinear mapping to obtain a third intermediate feature f^{s}, and a specific calculation process is shown in the following formulas (4) and (5):

$${f}_{i}^{s} = {k}_{i} {f}_{i}^{{s}^{′}} \qquad ( 4 )$$

$${f}_{s} = {\sum }_{i = 0}^{C} {f}_{i}^{s} \qquad ( 5 )$$

wherein

$${k}_{i} = \{ \begin{matrix}1 + {ϵ}_{i} & if {f}_{i}^{s} > 0 \\ {α}_{i} & if {f}_{i}^{s} < 0\end{matrix} ,$$

and i represents an ith channel; that is, the feature map f′₁ is subjected to channel-wise nonlinear mapping, nonlinear mapping functions of the channels can be different, and mapping parameters ∈ᵢ and kᵢ of each channel are required to be obtained through learning.

During data processing in the nonlinear mapping mode, for a negative value input, compared with the operation that relu directly maps an input with a value of 0 or less than 0 into 0 for outputting, positive and negative responses of the convolution kernel can be considered to be accepted; that is, a face is required to learn the negative value input. More complex relationships in data can be learned by applying such a nonlinear mapping mode. Secondly, it is beneficial to depthwise learning mapping values, that is, performing channel-independent weight learning, which can be regarded as a mode of learning the attention among different channels, and enhances accuracy of attention circulation among the channels. Furthermore, for the channel-wise mapping mode, nonlinear mapping gradually becomes more “nonlinear” in a depth increasing process; that is, the model tends to keep information in a shallow network and enhance discrimination in a deep network, which generally means that the low-layer feature map has a high resolution, weak semantic information and rich spatial information, and the high-layer feature map has a low resolution and strong semantic information.

Further, f^{s} is multiplied by

$${f}_{1}^{c}$$

to obtain the fourth intermediate feature map f^{c} with the dimensions (N, C, H, W), and a specific calculation process is shown in the following formula (6):

$${f}^{c} = {f}^{s} \cdot {f}_{1}^{c} \qquad ( 6 )$$

In order to further enhance a feature expression capability, the fourth intermediate feature map f^{c} is subjected to nonlinear mapping to obtain the attention circulation feature map f^{C}, and a specific calculation process is shown in the following formulas (7) and (8):

$${f}_{i}^{c} = {k}_{i} {f}_{i}^{c} \qquad ( 7 )$$

$${f}^{C} = {\sum }_{i = 0}^{C} {f}_{i}^{C} \qquad ( 8 )$$

wherein

$${k}_{i} = \{ \begin{matrix}1 + {ϵ}_{i} & if {f}_{i}^{c} > 0 \\ {α}_{i} & if {f}_{i}^{c} < 0\end{matrix} ,$$

and f^{c} represents the feature map with the attention fully circulated in both spatial and channel directions until an attention flow of interest spans the entire feature space.

As can be seen from the above, the dimensions of f^{c} are (N, C, H, W) and consistent with the dimensions of the input feature map f₁, and therefore, the attention circulation technology can be inserted into any module and any position of a neural network as a plug-and-play module, and a usage manner is flexible. In the attention circulation technology, more effective feature fusion is mainly performed through the circulation of the attention between the spaces and the channels, and the feature expression capacity is enhanced in the positive and negative response channel-wise learning nonlinear mapping mode, such that more discriminative face features can be extracted. If this attention circulation technology is defined as an SC function with an input f₁ and an output f^{C}, the following attention circulation formula (9) can be obtained:

f^{C}=SC(f₁) (9)

In the embodiment of the present disclosure, an attention circulation module may be formed according to the attention circulation technology as a basic constituent module of the neural network. The module can be subjected to a refined convolution module design for structural particularity of the face, thus achieves the function of extracting the strongly discriminative face features with a smallest calculation quantity, and effectively focuses the attention of the feature map on a region favorable for the recognition task.

When the attention circulation module is applied in the step S201 to the step S204, an implementation process of the step S201 to the step S204 may be detailed as follows.

In the step S202, the depthwise convolution processing may be performed on the first feature map, and batch normalization processing may be performed on the depthwise convolution result to obtain the second feature map. Specifically, a depthwise convolution calculation (DWConv) with a convolution kernel of n×n (n>1), an input channel number of C, an output channel number of C, padding of 1, and a stride of s may be performed, and then, batch normalization (BatchNorm, abbreviated as BN) may be performed, so as to obtain a result f′₁ by a calculation; taking n=3 as an example, a specific calculation process is shown in the following formula (10):

f′₁=BN(DWConv(f₁,3×3)) (10)

The stride varies depending on a network design, and is a configurable hyper-parameter. In the embodiment of the present disclosure, based on the idea of designing a small-sized module, the parameter number is reduced by using the depthwise convolution instead of a normal convolution, and the parameter number of the depthwise convolution can be calculated to be 1/C of the normal conventional convolution. It should be particularly noted that, here, the convolution kernel of 3×3 may be replaced by a larger convolution kernel, such as 5×5 or 7×7, but the convolution kernel of 3×3 is most cost-effective.

In the step S203, the output f′₁ of the step S202 is subjected to the attention circulation calculation to obtain

$${f}_{1}^{C} ,$$

and a specific calculation process is shown in the following formula (11):

$${f}_{1}^{C} = SC ( {f}_{1}^{′} ) \qquad ( 11 )$$

In the step S204, the channel increasing convolution processing includes: performing convolution processing for increasing the channels by N times on the input feature map, and performing batch normalization processing on the convolution result, wherein N is a natural number; the channel reducing convolution processing includes: performing convolution processing for reducing the channels to 1/N on the input feature map, and performing batch normalization processing on the convolution result. Specifically, in the step S204, the following steps may be sequentially performed:
performing a convolution calculation (Conv) with a convolution kernel of 1×1, an input channel number of C, an output channel number of C*expansion (expansion coefficient), and a stride of 1 on the output

$${f}_{1}^{C}$$

of the step S202, and then performing batch normalization to obtain a result f₂, a specific calculation process being shown in the following formula (12):

$${f}_{2} = B N ( C o n v ( {f}_{1}^{C} , 1 \times 1 ) ) \qquad ( 12 )$$

performing the attention circulation calculation on f₂ to obtain

$${f}_{2}^{C} ,$$

a specific calculation process being shown in the following formula (13):

$${f}_{2}^{C} = S C ( {f}_{2} ) \qquad ( 13 )$$

performing a convolution calculation with a convolution kernel of 1×1, an input channel number of C*expansion, an output channel number of C, and a stride of 1 on

$${f}_{2}^{C} ,$$

and then performing batch normalization to obtain a result f₃, a specific calculation process being shown in the following formula (14):

$${f}_{3} = B N ( Conv ( {f}_{2}^{C} , 1 \times 1 ) ) \qquad ( 14 )$$

performing the attention circulation calculation on f₃ to obtain

$${f}_{3}^{C} ,$$

a specific calculation process being shown in the following formula (15):

$${f}_{3}^{C} = S C ( {f}_{3} ) \qquad ( 15 )$$

The embodiment of the present disclosure provides the lightweight attention circulation module which is subjected to the refined design for the facial recognition technology, and technologies such as a convolution design, linear and nonlinear mapping, or the like, all follow the following two principles: firstly, network parameters are reduced, the calculation quantity is saved, and an operation speed is improved; secondly, more effective feature fusion is carried out on the spatial dimension and the channel dimension, the feature expression capability is enhanced, and the more discriminative face features are extracted.

The number of the basic channels of the attention circulation module in the embodiment of the present disclosure may be designed to be 64, the dimension of the tensor thereof is quite low, and the convolution calculation quantity of the low-dimension tensor is also quite small, thus realizing a relatively high overall operation speed. If the whole network carries out feature extraction in a low-dimensional space, incompleteness of information and unrobustness of features are likely to be caused, and in the embodiment of the present disclosure, channel number expansion with a set expansion coefficient is carried out in the middle convolution processing process, such that a feature extraction capability of the whole module can be improved to realize delicate balance between the calculation quantity and the feature expression capability.

In the embodiment of the present disclosure, the whole attention circulation module enables the attention flow concerned by the facial recognition task to be circulated and transformed between the spaces and the channels through the combination of the operations, such as the convolutions, expansion and compression of the channel numbers, attention circulation technologies, or the like, of different types, feature fusion is more efficient, the feature map is finally and effectively focused on the interested region of facial recognition, and furthermore, the attention circulation module also has the advantages of a small parameter number, a small calculation quantity and a high speed.

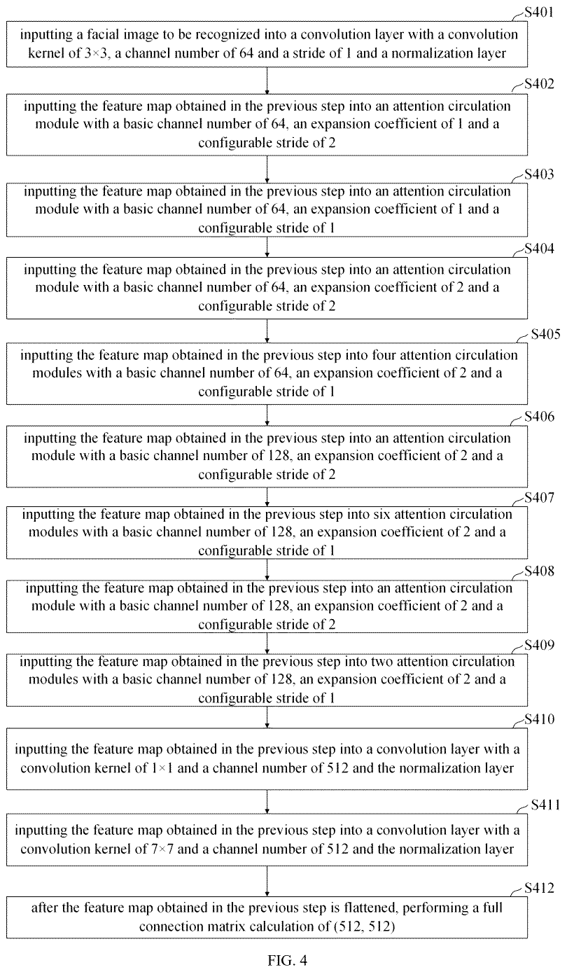

As shown in FIG. 4, a facial recognition method according to the embodiment of the present disclosure includes the following steps:
step S401: inputting a facial image to be recognized into a convolution layer with a convolution kernel of 3×3, a channel number of 64 and a stride of 1 and a normalization layer. In a specific embodiment, a resolution of the facial image to be recognized is (1, 3, 112, 112). A resolution of a feature map output in the step S401 is (1, 64, 112, 112).
Step S402: inputting the feature map obtained in the previous step into an attention circulation module with a basic channel number of 64, an expansion coefficient of 1 and a configurable stride of 2. A resolution of a feature map output in the step S402 is (1, 64, 56, 56).
Step S403: inputting the feature map obtained in the previous step into an attention circulation module with a basic channel number of 64, an expansion coefficient of 1 and a configurable stride of 1. A resolution of a feature map output in the step S403 is (1, 64, 56, 56).
Step S404: inputting the feature map obtained in the previous step into an attention circulation module with a basic channel number of 64, an expansion coefficient of 2 and a configurable stride of 2. A resolution of a feature map output in the step S404 is (1, 64, 28, 28).
Step S405: inputting the feature map obtained in the previous step into four attention circulation modules with a basic channel number of 64, an expansion coefficient of 2 and a configurable stride of 1. A resolution of a feature map output in the step S405 is (1, 64, 28, 28).
Step S406: inputting the feature map obtained in the previous step into an attention circulation module with a basic channel number of 128, an expansion coefficient of 2 and a configurable stride of 2. A resolution of a feature map output in the step S406 is (1, 128, 14, 14).
Step S407: inputting the feature map obtained in the previous step into six attention circulation modules with a basic channel number of 128, an expansion coefficient of 2 and a configurable stride of 1. A resolution of a feature map output in the step S407 is (1, 128, 14, 14).
Step S408: inputting the feature map obtained in the previous step into an attention circulation module with a basic channel number of 128, an expansion coefficient of 2 and a configurable stride of 2. A resolution of a feature map output in the step S408 is (1, 128, 7, 7).
Step S409: inputting the feature map obtained in the previous step into two attention circulation modules with a basic channel number of 128, an expansion coefficient of 2 and a configurable stride of 1. A resolution of a feature map output in the step S409 is (1, 128, 7, 7).
Step S410: inputting the feature map obtained in the previous step into a convolution layer with a convolution kernel of 1×1 and a channel number of 512 and the normalization layer. A resolution of a feature map output in the step S410 is (1, 512, 7, 7).
Step S411: inputting the feature map obtained in the previous step into a convolution layer with a convolution kernel of 7×7 and a channel number of 512 and the normalization layer. A resolution of a feature map output in the step S411 is (1, 512, 1, 1).
Step S412: after the feature map obtained in the previous step is flattened, performing a full connection matrix calculation of (512, 512) to obtain a 512-dimensional vector as a target feature map.

In the facial recognition method shown in FIG. 4, the step S402 and the step S403 may be regarded as one stage, the step S404 and the step S405 may be regarded as one stage, the step S406 and the step S407 may be regarded as one stage, the step S408 and the step S409 may be regarded as one stage, the numbers of the attention circulation modules included in the stages are (2, 5, 7, 3), but the combination manner of the attention circulation modules is only exemplary, and the technical effect of the technical solution of the embodiment of the present disclosure can be achieved by other combination manners of the attention circulation modules.

The technical solution of the embodiment of the present disclosure provides the universal attention circulation technology, which can effectively capture the attention on the space and the channel, and improve feature discrimination in the channel-wise learnable nonlinear mapping mode, and the whole technology can extract the effective feature combination mode, thereby promoting the circulation of the attention in multiple directional dimensions.

In the facial recognition method according to the embodiment of the present disclosure, feature map processing of facial recognition is carried out through a combination of the convolution processing and the attention circulation processing, and the circulation of the attention in multiple directional dimensions is promoted, such that the finally obtained feature map has high discrimination on all the directional dimensions, thereby improving the recognition precision of the facial recognition model.

An apparatus according to the embodiments of the present disclosure is described below, and may be configured to perform the method according to the embodiments of the present disclosure. The facial recognition apparatus described below and the facial recognition method described above may be correspondingly referred to each other. For details not disclosed in the embodiments of the apparatus according to the present disclosure, reference is made to the embodiments of the method according to the present disclosure.

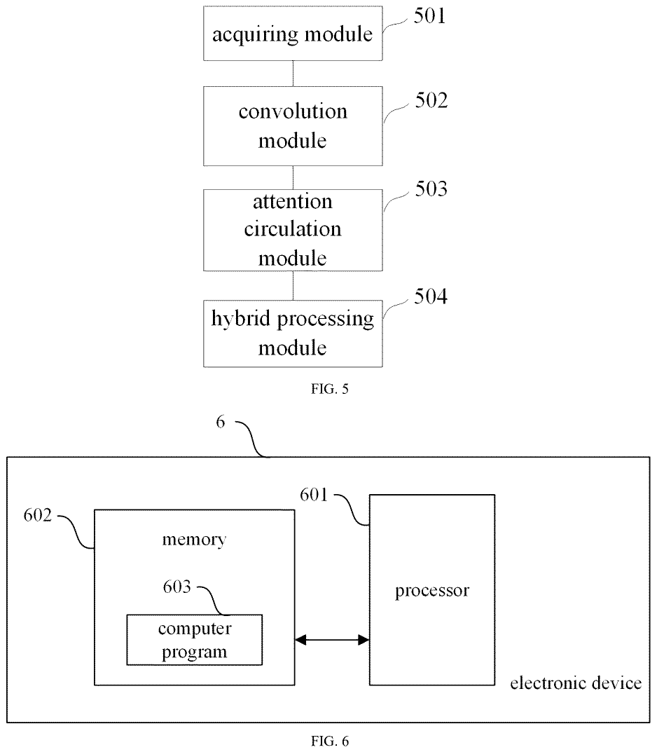

FIG. 5 is a schematic diagram of a facial recognition apparatus according to an embodiment of the present disclosure. As shown in FIG. 5, the facial recognition apparatus includes:
an acquiring module 501 configured to acquire a first feature map of a facial image to be recognized.

Specifically, the first feature map is a 4-dimensional tensor having dimensions (N, C, H, W), N representing a number of batch-processed images, C representing a number of channels, H representing a height, and W representing a width. The first feature map is obtained by extracting features of the facial image to be recognized.

A convolution module 502 configured to perform depthwise convolution processing on the first feature map, so as to obtain a second feature map.

Specifically, for a depthwise convolution, a convolution operation is performed in each independent channel, each convolution kernel performs one calculation on each channel in a conventional convolution, and each convolution kernel performs calculations on only one channel in the depthwise convolution.

An attention circulation module 503 configured to perform attention circulation processing on the second feature map, so as to obtain a third feature map.

Specifically, the attention circulation processing may cause the attention to be circulated between the spaces and the channels to perform more effective feature fusion.

A hybrid processing module 504 configured to sequentially perform, on the third feature map, channel increasing convolution processing, attention circulation processing, channel reducing convolution processing, and attention circulation processing, so as to obtain a target feature map corresponding to the first feature map.

Specifically, the channel increasing convolution processing and the channel reducing convolution processing are two corresponding conventional convolution calculation processes, the channel increasing convolution processing is performed first to increase the number of the channels, and then, the channel reducing convolution processing is performed to restore the number of the channels to the previous number.

According to the technical solution of the embodiment of the present disclosure, through the attention circulation processing, the effective feature combination mode can be extracted to promote the circulation of the attention in multiple directional dimensions. Through the design and combination of the attention circulation processing technology and different types of convolutions, requirements of the facial recognition task and lightweight requirements of the embedded device can be met simultaneously, and compared with the prior art, higher recognition precision can be realized by using a smaller number of parameters.

In the embodiment of the present disclosure, the attention circulation module 503 may be further configured to: flatten a first dimension and a second dimension of an input feature map to obtain a first intermediate feature map; acquire a second intermediate feature map according to the first intermediate feature map and a first learnable parameter matrix; acquire a spatial attention feature map according to a product of the second intermediate feature map and the input feature map; acquire a channel attention feature map according to a second learnable parameter matrix, a third learnable parameter matrix and the spatial attention feature map, a first dimension of the second learnable parameter matrix being equal to a second dimension of the third learnable parameter matrix, and a first dimension of the third learnable parameter matrix being equal to a second dimension of the second learnable parameter matrix; and acquire an attention circulation feature map according to the spatial attention feature map and the channel attention feature map.

In the technical solution of the embodiment of the present disclosure, a first product of the first intermediate feature map and a function value of a logistic regression function softmax thereof may be obtained, and then, the second intermediate feature map may be obtained according to a mean value of the first product. Specifically, the first intermediate feature map may be right multiplied by the first learnable parameter matrix to obtain a tensor, a Hadamard product of the softmax function value of the tensor and the tensor is further calculated to obtain a matrix, and the matrix is averaged in a certain dimension to obtain the second intermediate feature map.

Specifically, the spatial attention feature map is a spatial attention-fused feature map. The first learnable parameter matrix may learn attention circulation information in a spatial dimension. The second learnable parameter matrix and the third learnable parameter matrix can learn attention circulation information in a channel dimension, and weights of the channels are learned by capturing feature relationships between different channels, such that features are more discriminative for information of the channels. The attention circulation feature map obtained according to the spatial attention feature map and the channel attention feature map can learn the attention circulation information in the spatial dimension and the channel dimension, thereby improving accuracy of attention circulation in the spatial dimension and the channel dimension.

In the embodiment of the present disclosure, the attention circulation module 503 may be further configured to: perform nonlinear mapping processing on the spatial attention feature map to obtain a third intermediate feature map; obtain a fourth intermediate feature map according to a product of the third intermediate feature map and the channel attention feature map; and perform nonlinear mapping processing on the fourth intermediate feature map to obtain the attention circulation feature map.

In the embodiment of the present disclosure, more complex relationships in data can be learned by applying such a nonlinear mapping mode. It is beneficial to depthwise learning mapping values, that is, performing channel-independent weight learning, which can be regarded as a mode of learning the attention among different channels, and enhances accuracy of attention circulation among the channels. Furthermore, for the channel-wise mapping mode, nonlinear mapping gradually becomes more “nonlinear” in a depth increasing process; that is, the model tends to keep information in a shallow network and enhance discrimination in a deep network, which generally means that the low-layer feature map has a high resolution, weak semantic information and rich spatial information, and the high-layer feature map has a low resolution and strong semantic information.

In the embodiment of the present disclosure, the attention circulation module 503 may be further configured to: acquire a first product of the first intermediate feature map and a logistic regression function value thereof, and obtain the second intermediate feature map according to a mean value of the first product.

In the embodiment of the present disclosure, the attention circulation module 503 may be further configured to: right multiply the spatial attention feature map by the second learnable parameter matrix to obtain a second product; and perform sparsification on the second product, and right multiply the second product by the third learnable parameter matrix to obtain the channel attention feature map.

In the embodiment of the present disclosure, the first learnable parameter matrix Q₁ is introduced to calculate and obtain r kinds of spatial linear transformation results, and all representative feature combination modes in the space can be extracted. In the extracted face feature map, although spatial pixels have the same receptive field, the receptive fields are mapped to different regions of the original image and have different contributions to the final recognition task, and therefore, different weights should be given to different pixels. The attention in the dimension H*W of the features can be learned by using the first learnable parameter matrix Q₁, such that the attention is circulated in the spatial dimension to obtain a fusion result of the plurality of feature combinations. The attention circulation information in the channel dimension can be learned by introducing the second learnable parameter matrix Q₂ and the third learnable parameter matrix Q₃, a feature relationship between the channels is more concerned in the design of this part, and a weight of each channel is learned by capturing the feature relationship between different channels, such that the features are more discriminative for each piece of channel information.

In the embodiment of the present disclosure, the hybrid processing module 504 may be further configured to: in the channel increasing convolution processing, perform convolution processing for increasing the channels by N times on the input feature map, and perform batch normalization processing on the convolution result, wherein N is a natural number; in the channel reducing convolution processing, perform convolution processing for reducing the channels to 1/N on the input feature map, and perform batch normalization processing on the convolution result.

In the embodiment of the present disclosure, the convolution module 502 may be further configured to: perform the depthwise convolution processing on the first feature map, and perform batch normalization processing on the depthwise convolution result to obtain the second feature map.

The embodiment of the present disclosure provides the lightweight attention circulation module which is subjected to the refined design for the facial recognition technology, and technologies such as a convolution design, linear and nonlinear mapping, or the like, all follow the following two principles: firstly, network parameters are reduced, the calculation quantity is saved, and an operation speed is improved; secondly, more effective feature fusion is carried out on the spatial dimension and the channel dimension, the feature expression capability is enhanced, and the more discriminative face features are extracted.

The number of the basic channels of the attention circulation module in the embodiment of the present disclosure may be designed to be 64, the dimension of the tensor thereof is quite low, and the convolution calculation quantity of the low-dimension tensor is also quite small, thus realizing a relatively high overall operation speed. If the whole network carries out feature extraction in a low-dimensional space, incompleteness of information and unrobustness of features are likely to be caused, and in the embodiment of the present disclosure, channel number expansion with a set expansion coefficient is carried out in the middle convolution processing process, such that a feature extraction capability of the whole module can be improved to realize delicate balance between the calculation quantity and the feature expression capability.

In the embodiment of the present disclosure, the whole attention circulation module enables the attention flow concerned by the facial recognition task to be circulated and transformed between the spaces and the channels through the combination of the operations, such as the convolutions, expansion and compression of the channel numbers, attention circulation technologies, or the like, of different types, feature fusion is more efficient, the feature map is finally and effectively focused on the interested region of facial recognition, and furthermore, the attention circulation module also has the advantages of a small parameter number, a small calculation quantity and a high speed.

The technical solution of the embodiment of the present disclosure provides the universal attention circulation technology, which can effectively capture the attention on the space and the channel, and improve feature discrimination in the channel-wise learnable nonlinear mapping mode, and the whole technology can extract the effective feature combination mode, thereby promoting the circulation of the attention in multiple directional dimensions.

Since each functional module of the facial recognition apparatus according to the exemplary embodiment of the present disclosure corresponds to the step of the exemplary embodiment of the facial recognition method, reference may be made to the embodiment of the facial recognition method according to the present disclosure for details not disclosed in the embodiment of the apparatus according to the present disclosure.

In the facial recognition apparatus according to the embodiment of the present disclosure, feature map processing of facial recognition is carried out through a combination of the convolution processing and the attention circulation processing, and the circulation of the attention in multiple directional dimensions is promoted, such that the finally obtained feature map has high discrimination on all the directional dimensions, thereby improving the recognition precision of the facial recognition model.

FIG. 6 is a schematic diagram of an electronic device 6 according to an embodiment of the present disclosure. As shown in FIG. 6, the electronic device 6 according to the present embodiment includes: a processor 601, a memory 602, and a computer program 603 stored in the memory 602 and executable on the processor 601. The steps in the various method embodiments described above are implemented when the processor 601 executes the computer program 603. Alternatively, the processor 601 achieves the functions of each module in each apparatus embodiment described above when executing the computer program 603.

The electronic device 6 may be a desktop computer, a notebook, a palm computer, a cloud server or another electronic device. The electronic device 6 may include, but is not limited to, the processor 601 and the memory 602. Those skilled in the art may understand that a structure shown in FIG. 6 is only an example of the electronic device 6 and does not limit the electronic device 6, which may include more or fewer or different components than those shown in the drawings.

The processor 601 may be a Central Processing Unit (CPU), or other general-purpose processors, Digital Signal Processors (DSP), Application Specific Integrated Circuits (ASIC), Field-Programmable Gate Arrays (FPGA) or other programmable logic devices, discrete gates or transistor logic devices, discrete hardware components, etc.

The memory 602 may be an internal storage unit of the electronic device 6, for example, a hard disk or memory of the electronic device 6. The memory 602 may also be an external storage device of the electronic device 6, such as a plug-in hard disk, a Smart Media Card (SMC), a Secure Digital (SD) Card, a Flash Card, or the like, configured on the electronic device 6. The memory 602 may also include both the internal storage unit and the external storage device of the electronic device 6. The memory 602 is configured to store the computer program and other programs and data required by the electronic device.

It may be clearly understood by those skilled in the art that, for convenient and brief description, division of the above functional units and modules is used as an example for illustration. In practical application, the above functions can be allocated to different functional units and modules and implemented as required; that is, an internal structure of the apparatus is divided into different functional units or modules to accomplish all or some of the functions described above. The functional units or modules in the embodiments may be integrated into one processing unit, or each of the units may exist alone physically, or two or more units are integrated into one unit, and the integrated unit may be implemented in a form of hardware, or may also be implemented in a form of a software functional unit.

The integrated module may be stored in a computer-readable storage medium when implemented in the form of the software functional unit and sold or used as a separate product. Based on such understanding, all or some of the processes in the method according to the above embodiments may be realized in the present disclosure, or completed by the computer program instructing related hardware, the computer program may be stored in the computer-readable storage medium, and when the computer program is executed by the processor, the steps of the above method embodiments may be realized. The computer program may include a computer program code, which may be in a form of a source code, an object code or an executable file or in some intermediate forms. The computer-readable medium may include any entity or apparatus capable of carrying the computer program code, a recording medium, a USB flash drive, a removable hard disk, a magnetic disk, an optical disk, a computer memory, a Read-Only Memory (ROM), a Random Access Memory (RAM), an electrical carrier signal, a telecommunication signal, a software distribution medium, and so on. It should be noted that content included in the computer-readable medium may be appropriately increased or decreased according to requirements of legislation and patent practice in a jurisdiction, for example, in some jurisdictions, according to legislation and patent practice, the computer-readable medium does not include the electrical carrier signal and the telecommunication signal.

The above embodiments are merely intended to describe the technical solutions of the present disclosure, but not to limit the present disclosure. Although the present disclosure is described in detail with reference to the foregoing embodiments, those of ordinary skill in the art should understand that they may still make modifications to the technical solutions described in the foregoing embodiments or make equivalent replacements to some technical features thereof. Such modifications or replacements do not cause the essence of the corresponding technical solutions to depart from the spirit and scope of the technical solutions of the embodiments of the present disclosure, and should be included in the protection scope of the present disclosure.

What is claimed is:

1. A facial recognition method, comprising:
acquiring a first feature map of a facial image to be recognized;
performing depthwise convolution processing on the first feature map to obtain a second feature map;
performing attention circulation processing on the second feature map to obtain a third feature map; and
sequentially performing, on the third feature map, channel increasing convolution processing, the attention circulation processing, channel reducing convolution processing, and the attention circulation processing to obtain a target feature map corresponding to the first feature map.

2. The facial recognition method according to claim 1, wherein the attention circulation processing comprises:
flattening a first dimension and a second dimension of an input feature map to obtain a first intermediate feature map;
acquiring a second intermediate feature map according to the first intermediate feature map and a first learnable parameter matrix;
acquiring a spatial attention feature map according to a product of the second intermediate feature map and the input feature map;
acquiring a channel attention feature map according to a second learnable parameter matrix, a third learnable parameter matrix, and the spatial attention feature map, a first dimension of the second learnable parameter matrix being equal to a second dimension of the third learnable parameter matrix, and a first dimension of the third learnable parameter matrix being equal to a second dimension of the second learnable parameter matrix; and
acquiring an attention circulation feature map according to the spatial attention feature map and the channel attention feature map.

3. The facial recognition method according to claim 2, wherein the step of acquiring the attention circulation feature map according to the spatial attention feature map and the channel attention feature map comprises:
performing nonlinear mapping processing on the spatial attention feature map to obtain a third intermediate feature map;
obtaining a fourth intermediate feature map according to a product of the third intermediate feature map and the channel attention feature map; and
performing the nonlinear mapping processing on the fourth intermediate feature map to obtain the attention circulation feature map.

4. The facial recognition method according to claim 2, wherein the step of acquiring the second intermediate feature map according to the first intermediate feature map and the first learnable parameter matrix comprises:
acquiring a first product of the first intermediate feature map and a logistic regression function value of the first intermediate feature map; and
obtaining the second intermediate feature map according to a mean value of the first product.

5. The facial recognition method according to claim 2, wherein the step of acquiring the channel attention feature map according to the second learnable parameter matrix, the third learnable parameter matrix, and the spatial attention feature map comprises:
right multiplying the spatial attention feature map by the second learnable parameter matrix to obtain a second product; and
performing a sparsification on the second product, and right multiplying the second product by the third learnable parameter matrix to obtain the channel attention feature map.

6. The facial recognition method according to claim 1,
wherein the channel increasing convolution processing comprises: performing convolution processing for increasing channels by N times on an input feature map to obtain a first convolution result, and performing batch normalization processing on the first convolution result, wherein N is a natural number;
the channel reducing convolution processing comprises: performing the convolution processing for reducing the channels to 1/N on the input feature map to obtain a second convolution result, and performing the batch normalization processing on the second convolution result.

7. The facial recognition method according to claim 6, wherein the step of performing the depthwise convolution processing on the first feature map to obtain the second feature map comprises:
performing the depthwise convolution processing on the first feature map to obtain a depthwise convolution result, and performing the batch normalization processing on the depthwise convolution result to obtain the second feature map.

8. A facial recognition apparatus, comprising:
an acquiring module configured to acquire a first feature map of a facial image to be recognized;
a convolution module configured to perform depthwise convolution processing on the first feature map to obtain a second feature map;
an attention circulation module configured to perform attention circulation processing on the second feature map to obtain a third feature map; and
a hybrid processing module configured to sequentially perform, on the third feature map, channel increasing convolution processing, the attention circulation processing, channel reducing convolution processing, and the attention circulation processing to obtain a target feature map corresponding to the first feature map.

9. An electronic device, comprising a memory, a processor, and a computer program stored in the memory and runnable on the processor, wherein the processor, when executing the computer program, implements steps of the facial recognition method according to claim 1.

10. A computer-readable storage medium storing a computer program, wherein the computer program, when executed by a processor, implements steps of the facial recognition method according to claim 1.
